(19) United States
(12) Patent Application Publication
(10) Pub. No.: US 2012/0153042 A1
(43) Pub. Date: Jun. 21, 2012

(54) Rolling lawn and garden sprinkler and sprayer

(76) Inventors: Jason Oedekoven, Recluse, WY (US); Cheri Irvin, Recluse, WY (US)

(21) Appl. No.: 12/928,742

(22) Filed: Dec. 17, 2010

(51) Int. Cl. A01G 25/09

(52) U.S. Cl. 239/172

(57) ABSTRACT

A rolling lawn and garden sprinkler and sprayer device is disclosed. The device is easily transported and maneuvered, can function as both a spot sprayer and a wide-area sprinkler, allows application of chemicals, and enhances the appearance of a lawn or garden. In one embodiment, the device resembles a large ladybug mounted on wheels and comprises a handle, one or more input ports, a plurality of storage/mixing containers, a plurality of valves and flow control devices, a plurality of sprinklers, and a plurality of spray wands. A user can activate the sprinkling feature and either water an area or mix water and chemicals, fertilizers, etc. and apply the mixture. Additionally, the device allows for spot application of water and/or chemicals by the user via activation of spray wand(s). The device can be towed by a lawn tractor, ATV, etc. and can incorporate a pump.

### TECHNICAL FIELD

This invention relates generally to the field of lawn and garden equipment and, more particularly, to a rolling lawn and garden sprinkler and sprayer.

### BACKGROUND

In order to properly grow and maintain a lawn and/or garden appropriate amounts of water need to be administered on a timely basis. Furthermore, application of fertilizer(s), pesticide(s), chemical(s), insecticide(s), etc. (hereinafter “chemicals” will be used to refer to any combination of one or more of the aforementioned substances or related substances employed in the lawn and garden industry) is often necessary as well. A number of different water delivery devices, commonly referred to as “sprinklers,” and chemical applicators, known as “sprayers,” have been developed in order to assist a gardener or lawn maintenance person in these tasks.

Various types of sprinkling devices are well known in the art, including: underground sprinkling systems; fixed, above-ground sprinklers; relocatable, non-moving sprinklers; and automated, traveling sprinklers. Additionally, various types of sprayers that provide for the application of chemicals are known in the art, including person-portable devices such as backpack-style tanks, hand-carried canisters, etc., as well as vehicle mounted tanks and sprayers. For examples of known sprinklers and sprayers see: U.S. Pat. No. 2,030,278 to Thorne; U.S. Pat. No. 7,083,118 to Bowles; U.S. Pat. No. 1,936,275 to Siebert; U.S. Pat. No. 1,873,992 to Boag; U.S. Pat. No. 6,471,141 to Smith; U.S. Pat. No. 5,335,690 to Worth; U.S. Pat. No. 7,703,703 to Gavin; U.S. Pat. No. 7,207,503 to Stengel; U.S. Pat. No. 7,344,091 to Caccaviello; U.S. Pat. No. 7,300,004 to Sinden; U.S. Pat. No. 6,604,697 to Heren; U.S. Pat. No. 2,712,960 to Grubb; U.S. Pat. No. 7,325,756 to Giorgis; U.S. Pat. No. 2,293,796 to Bestor; U.S. Pat. No. 2,883,116 to Muench; U.S. Pat. No. 6,161,779 to Oyler; U.S. Pat. No. 5,950,928 to Giang; U.S. Pat. No. 5,549,248 to Baker; U.S. Pat. No. 5,419,494 to Harwood; U.S. Pat. No. 5,609,417 to Otte; and U.S. Pat. No. 6,722,583 to Restaino.

As can be gathered from a review of the above, the known devices are generally designed to be either a sprinkler or a sprayer and do not handle both tasks efficiently. For example, in-ground sprinkler systems are quite common but usually do not allow chemicals to be applied with the water as such chemicals can corrode or damage the system. Furthermore, although some relocatable, non-moving sprinklers do allow application of chemicals during the sprinkling process, they do not additionally allow spot application of chemicals as needed. Conversely, person-portable spraying devices provide for easy spot application of chemicals, but do not also function as sprinklers. Furthermore, known person-portable spraying devices often require heavy-lifting and a high-level of sustained energy output by the user to operate and maneuver the devices, while vehicle mounted sprayers require vehicular access to an area and subject the lawn/garden to impacts from the presence of the vehicle. Finally, many devices currently employed in the art have appearances that detract from the beauty of the lawn or garden and are therefore used as little as possible and then hidden away afterwards, making them less than ideally suited for the nearly constant needs associated with sprinkling and spraying a lawn or garden.

Therefore, a need exists for a lawn and garden sprinkler and sprayer that is easily relocated without the need for a heavy vehicle; functions as both a sprayer and a sprinkler; allows fertilizers, chemicals, insecticides, pesticides, etc. to be mixed and dispensed in either spot or area-wide applications; and enhances the appearance of a lawn or garden.

### SUMMARY

Embodiments of the present invention described and claimed herein address at least some of the foregoing limitations and problems by providing a rolling lawn and garden sprinkler and sprayer that is easily transported and maneuvered, can function as both a spot sprayer and a wide-area sprinkler, allows application of chemicals, and enhances the appearance of a lawn and/or garden. In one embodiment, the device resembles a large ladybug mounted on inflatable tires and comprises a pull-handle, water input, a plurality of chemical storage and mixing containers, a plurality of sprinklers, and a plurality of spray wands. The pull-handle and inflatable tires allow a user to easily maneuver the device around a garden or lawn without unduly impacting the flora or churning/compacting the soil. In other embodiments, other types of tires/wheels can be used. Once placed in an appropriate location, the user can activate the sprinkling feature and allow the device to apply water to a wide area. If the user wishes to apply chemicals concurrently with the water, the device provides a simple adjustment which allows the chemicals carried in on-board storage to be mixed with water and applied via the sprinkling feature. Additionally, if the user wishes to make spot application of water and/or chemicals, the user can activate the plurality of spray wands. A wand can be directed to the appropriate spot and application of water and/or chemicals can be carried out.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a side elevation view of an exemplary embodiment of a rolling lawn and garden sprinkler and sprayer in accordance with an aspect of the present invention;

FIG. 2 illustrates a top plan view of an exemplary embodiment of a rolling lawn and garden sprinkler and sprayer;

FIG. 3 illustrates a side elevation view of the liquid flow routes of an exemplary embodiment of a rolling lawn and garden sprinkler and sprayer;

FIG. 4 illustrates a side elevation view depicting a portion of the front wheel assembly, handle, and pump of a hand-pulled embodiment of a rolling lawn and garden sprinkler and sprayer; and

FIG. 5 illustrates a side elevation view depicting a portion of the front wheel assembly, a plurality of tow hitches, and a pump of an exemplary, vehicle-pulled embodiment of a rolling lawn and garden sprinkler and sprayer.

### DETAILED DESCRIPTION

In the following discussion, numerous specific details are set forth to provide a thorough understanding of the present invention. However, those skilled in the art will appreciate that the present invention may be practiced without such specific details.

The rolling lawn and garden sprinkler and sprayer provides many benefits over the prior art. For example, not only can it function as a broad-area sprinkler, but it can also incorporate chemicals into the water stream(s) so as to function as a broad-area fertilizer/sprayer. Additionally, it can provide spot application of water and/or chemicals as well through the use of one or more spray wands. The unit is easily relocatable as it incorporates a wheeled chassis resting on relatively large tires to minimize the impact of the device on the lawn/garden. Furthermore, the unit's handle allows a single person to turn the front wheels and easily push or pull the unit across the lawn or into a desired location. The handle can also be configured so that a vehicle such as a lawn tractor, all-terrain-vehicle, etc. can maneuver the unit as well. Numerous valves provide the user with a means of redirecting the water flow through the unit so that chemicals can be mixed with the water stream or pure water can be output. Other benefits and advantages of the present invention will become apparent through review of the following detailed descriptions of the drawing figures.

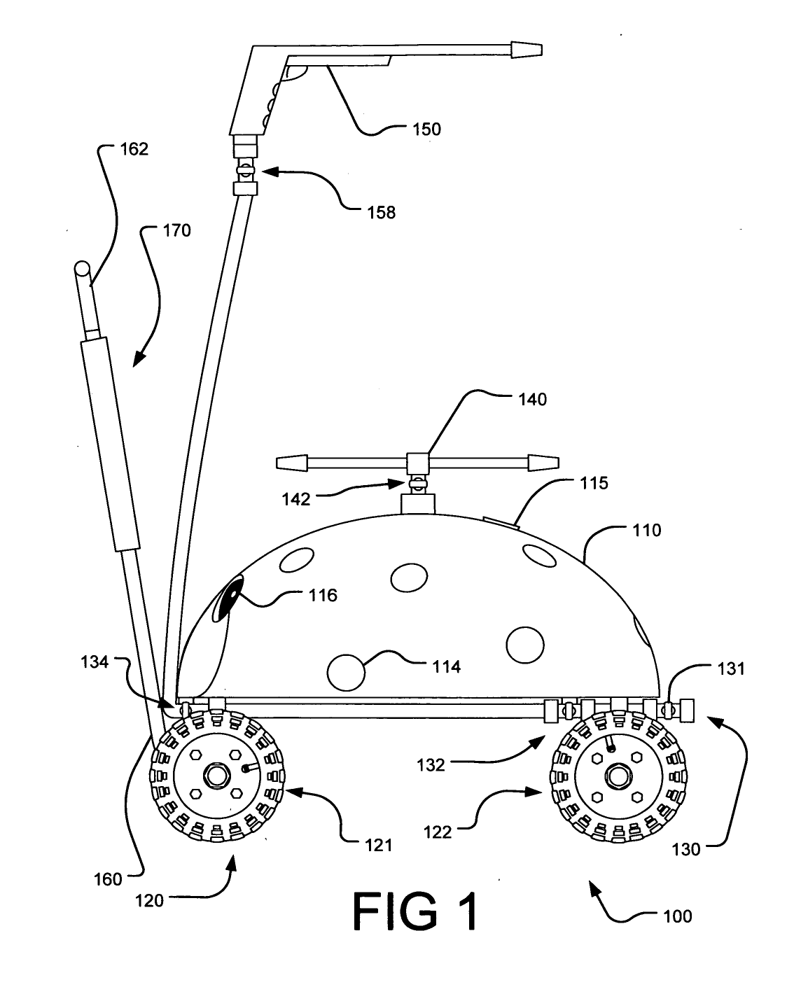

Referring to FIG. 1 of the drawings, the reference numeral 100 generally designates a rolling lawn and garden sprinkler and sprayer in accordance with an aspect of the present invention. In one embodiment, the sprinkler and sprayer 100 comprises a frame 110, a wheeled chassis 120, an input port 130, a sprinkler 140, a sprayer 150, and a tow bar 160.

As can be seen from the illustration in FIG. 1, the frame 110 can be shaped so as to resemble a ladybug. This configuration not only enhances the appearance of a lawn or garden in which the unit is being employed, but also allows for the inside of the frame 110 to act as a storage tank for the mixing of chemicals. The outside of the frame 110 can have a plurality of spots 114 to further enhance the resemblance of the device 100 to a ladybug. Other visual enhancements include a representation of a ladybug's head 116.

As illustrated in FIG. 1, an access port 115 can be placed near the top of the frame 110 and can be made to resemble one of the plurality of spots 114. The port 115 allows access to the inside of the frame 110 for addition of chemicals, for maintenance, etc. Disguising the port 115 as just another spot 114 contributes to the aesthetic appearance of the device 100 and the location in which the device 100 is being employed, while maintaining functionality thereof.

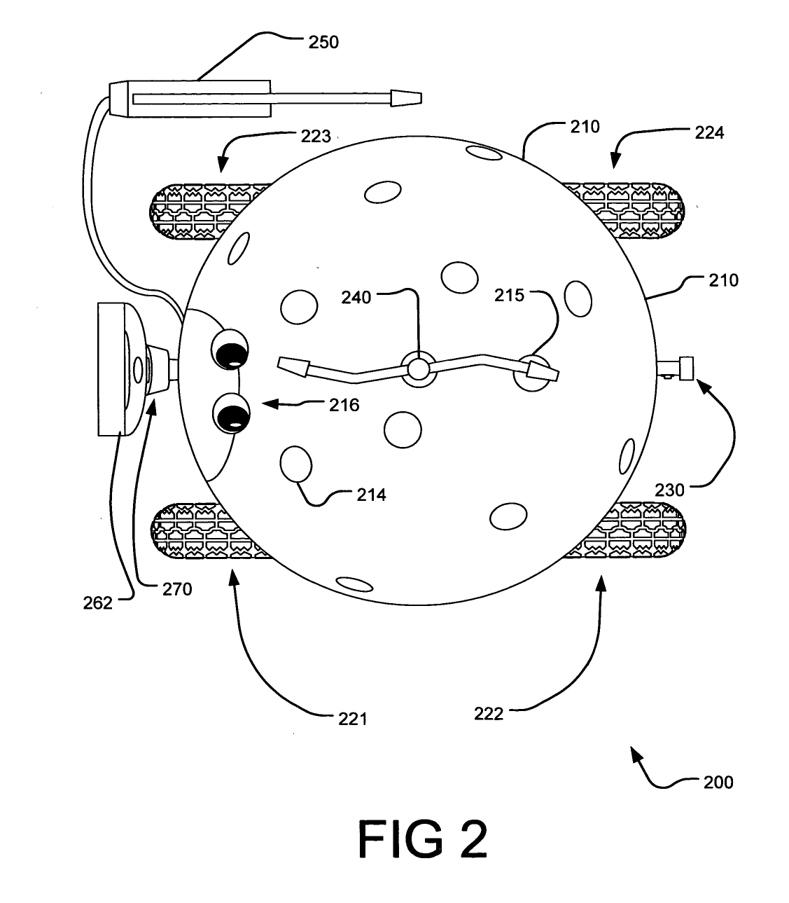

Attached to the frame 110 is a wheeled chassis 120. In one embodiment, the chassis is permanently affixed to the frame 110; in another embodiment, the frame 110 can be removably affixed to the chassis 120. The plurality of wheels 121 and 122 can be configured in a number of different ways to provide appropriate advantages. As can be seen in FIG. 1, the plurality of wheels 121 and 122 are represented by the two visible wheels 121 and 122. As can be seen more clearly in FIG. 2, four wheels 221, 222, 223 and 224 are actually being employed in the embodiment illustrated therein. In other embodiments the number of wheels may vary. The wheels 121 and 122 use inflatable turf-type tires to minimize damage to surfaces/vegetation across which the device is maneuvered. Other types of wheels/tires are contemplated in other embodiments; for example, wheels incorporating aeration devices can be employed to help aerate a lawn as the device is maneuvered thereon, etc.

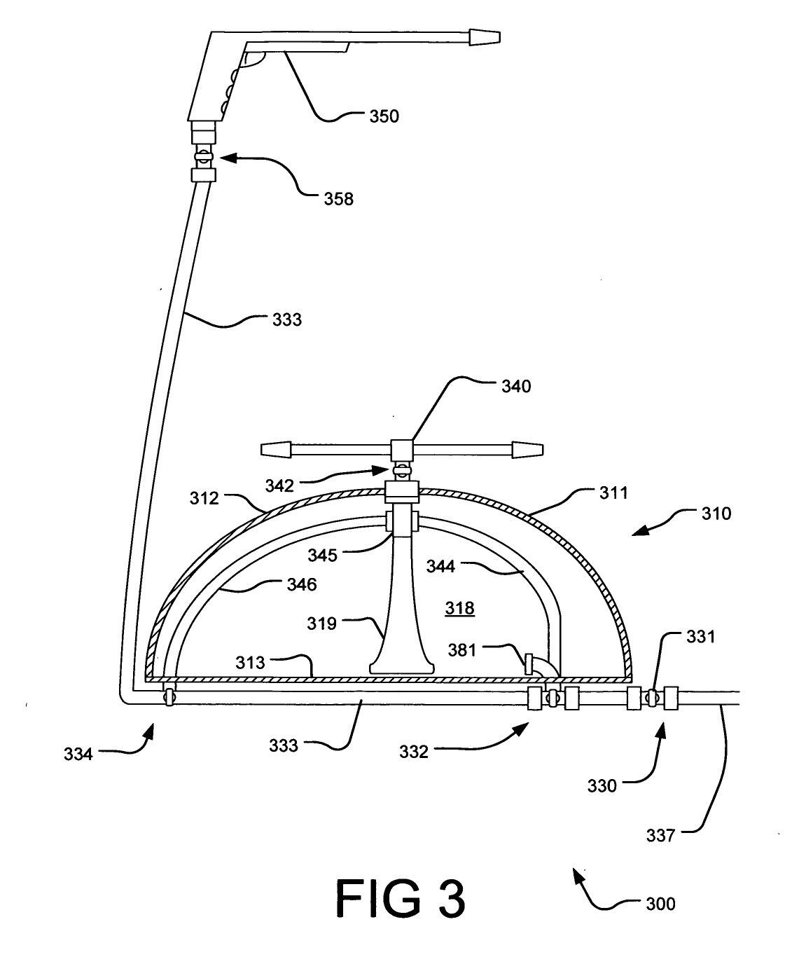

Although much of the liquid flow paths are not shown in FIG. 1, the primary input(s) and output(s) are visible (see FIG. 3 for a more detailed review of the flows). As illustrated in FIG. 1, the device utilizes at least one input port 130. In other embodiments, multiple inputs are contemplated. The input port 130 can be configured to accept a number of different connections; one embodiment uses a standard-size, female, garden hose connection for attachment of a standard garden hose thereto. Incorporated into the input port 130, or as a separate attachment component, is an input valve 131. The input valve can be a simple on/off valve, an on/off valve with a rate-of-flow restrictor, an on/off restrictor valve with a check valve to ensure that liquid only flows into the device 100, etc.

The liquid flow paths of the device 100 allow incoming liquid (normally water, but not limited thereto) to be directed through a number of routes. If un-enhanced sprinkling is desired, the incoming liquid enters the input port 130 and is routed to the sprinkler 140. A multi-directional valve 132 can accomplish this by selecting from a number of routes for the incoming liquid to travel within. In this instance, the muli-directional valve 132 can route the incoming liquid to the sprinkler 140; other routing directions can include to a mixing/storage chamber, to a sprayer 150, etc. If enhanced sprinkling utilizing chemicals mixed with the incoming liquid is desired, the liquid flow can be routed by the multi-directional valve 132 into one or more chambers that hold and/or mix the chemicals with the incoming liquid before the liquid is then routed to the sprinkler 140.

The sprinkler 140 can utilize any of a plethora of known sprinkling heads and can be made to be easily interchanged based upon the needs of the user. For example, a long-range sprinkler head can be used when the device 100 is employed to water a relatively large section of lawn. If, instead, the device 100 is employed to water a small garden plot, a short-range sprinkler head can be used instead. The sprinkler 140 can be turned on and off via the sprinkler valve 142. The sprinkler valve 142 can be a simple on/off valve, an on/off valve with an adjustable flow-rate, a check-valve can be incorporated, etc. As part of the sprinkler valve 142 assembly, a quick attach/release coupler can be utilized to allow for quick removal and replacement of the sprinkler 140. In another embodiment, no sprinkler valve 142 is used. In yet another embodiment, the sprinkler 140 does not utilize a quick attach/release coupler and/or may not be easily replaced with other sprinkler heads.

The liquid flow paths of the device 100 can allow incoming liquid to be routed to a sprayer 150. As with the routing to the sprinkler 140, the sprayer 150 can receive un-enhanced incoming liquid or it can receive liquid that has been mixed with chemicals. A multi-directional valve 132 can select one or the other of those routes and the sprayer flow valve 134 can be turned on/off to control flow of mixed or unmixed liquid to the sprayer 150. The sprayer 150 can employ a separate sprayer valve 158 in proximity to the sprayer 150 itself. The sprayer valve 158 can be a multi-function valve that allows flow control, quick-coupling removal and attachment of various sprayer wands, a check-valve, etc. In another embodiment, no sprayer valve 158 is used. In yet another embodiment, the sprayer 150 does not utilize a quick attach/release coupler and/or may not be easily replaced with other spray wands.

In the embodiment shown in FIG. 1, the sprayer 150 can utilize any of a plethora of known spray wands and can be made to be easily interchanged based upon the needs of the user. For example, a long-range spray wand can be used when the device 100 is employed to apply an incoming liquid or liquid/chemicals mixture to a distant target (such as the top of a tree). If, instead, the device 100 is employed to target individual weeds on the ground in proximity to the device 100, then a short-range spray wand can be used instead.

FIG. 1 illustrates a tow bar 160 and related assembly. The tow bar 160 attaches to the wheels assembly and/or frame 110 and allows for a user to maneuver the device 100. In one embodiment, the tow bar 160 can be swung left and right causing the front set of wheels 121 and 123 (not shown in FIG. 1, see FIG. 2, item 223) to turn accordingly. The user can pull on the tow bar 160 to cause the device 100 to move in the direction in which it is being pulled. In the embodiment shown in FIG. 1, a pump 170 is illustrated attached to the tow bar 160. The pump 170 can be used to pressurize the storage/mixing chamber and/or to move liquid/chemicals through the device 100. The pump 170 can be manually operated wherein a twist of the locking feature unlatches the handle 162 and allows the handle 162 to be moved up and down to operate the pump 170. Other types of locking features are contemplated. The handle 162 can be configured in any of a large number of different embodiments without departing from the scope of the invention.

It is important to understand that there are many potential flow routings that can be made depending on the types of valves, plumbing components, etc. that are used without departing from the scope of the invention.

FIG. 2 illustrates a top plan view of an exemplary embodiment of a rolling lawn and garden sprinkler and sprayer 200. From this viewing angle, it is easier to see the resemblance of the device 200 to a ladybug. The resemblance helps to enhance the appearance of a lawn or garden in which the device 200 is employed rather than detracting from the lawn or garden as many known devices currently do. The outside of the frame 210 can have a plurality of spots 214 to further enhance the resemblance of the device 200 to a ladybug. Other visual enhancements include a representation of a ladybug's head 216. It is contemplated that the device could be shaped and enhanced to appear like other types of bugs a well.

As illustrated in FIG. 2, an access port 215 can be placed near the top of the frame 210 and can be made to resemble one of the plurality of spots 214. The port 215 allows access to the inside of the frame 210 for addition of chemicals, for maintenance, etc. Disguising the port 215 as just another spot 214 contributes to the aesthetic appearance of the device 200 and the location in which the device 200 is being employed, while maintaining functionality thereof.

The plurality of wheels 221, 222, 223, and 224 are illustrated in FIG. 2. As described above, the frame 210 attaches to a wheeled chassis. In one embodiment, the chassis is permanently affixed to the frame 210, in another embodiment, the frame 210 can be removably affixed to the chassis. The plurality of wheels 221, 222, 223, and 224 can be configured in a number of different ways to provide appropriate advantages. For example, in some embodiments the number of wheels may vary. The wheels 221, 222, 223, and 224 illustrated in FIG. 2 use inflatable turf-type tires to minimize damage to surfaces/vegetation across which the device is maneuvered. Other types of wheels/tires are contemplated in other embodiments.

FIG. 2 also shows the input 230, the sprinkler 240, the sprayer 250, the pump 270, and the handle 262.

FIG. 3 illustrates a side elevation view of the liquid flow routes of an exemplary embodiment of a rolling lawn and garden sprinkler and sprayer 300. A cross-section of the frame 310 is displayed, comprising: a back shell 311, a front shell 312 and a bottom shell 313. The frame 310 is shown in cross-section in order to clearly illustrate that a number of the flow pathways or plumbing components can be placed within the frame. Furthermore, FIG. 3 illustrates that the front shell 312, the back shell 311, and the bottom shell 313 form a space which defines the plurality of mixing/storage chambers 318. In other embodiments, various plumbing components are routed externally.

As illustrated in FIG. 3, the device utilizes at least one input 330. In other embodiments, multiple inputs are contemplated. The input 330 can be configured to accept a number of different connections; one embodiment uses a standard-size, female, garden hose connection for attachment of a garden hose 337 thereto. Incorporated into the input 330, or as a separate attachment component, is an input valve 331. The input valve can be a simple on/off valve; an on/off valve with a rate-of-flow restrictor; an on/off restrictor valve with a check valve to ensure that liquid only flows into the device 300; an automatically timed or remote operated on/off valve which could turn on the sprinkling function of the device everyday at 7 am for one hour, for example; etc.

The liquid flow routes of the device 300 allow incoming liquid (normally water, but not limited thereto) to be routed in a number of ways. If direct, un-enhanced sprinkling is desired, the incoming liquid enters the input 330 and is routed to the sprinkler 340. A multi-directional valve 332 can accomplish this by selecting from a number of routes for the incoming liquid to travel though. In this instance, the muli-directional valve 332 can select routing the incoming liquid to the sprinkler 340; other directions can include to a mixing/storage chamber 318, to a sprayer 350, etc. If enhanced sprinkling utilizing chemicals mixed with the incoming liquid is desired, the liquid flow can be routed by the multi-directional valve 332 through a chamber input port 381 and into a plurality of chambers 318 that hold and/or mix the chemicals with the incoming liquid before the liquid is then routed to the sprinkler 340.

Routing of the un-enhanced incoming liquid from the multi-directional valve 332 to the sprinkler 340 is accomplished by the valve 332 routing the liquid into the sprinkler pipe 344, through the junction 345 and into the sprinkler 340. A sprinkler valve 342 can also be employed. As discussed above, one or more of the components that are shown inside of the frame 310 can be located outside the frame 310.

The sprinkler 340 can be turned on and off via the sprinkler valve 342. The sprinkler valve 342 can be a simple on/off valve, an on/off valve with an adjustable flow-rate, it can incorporate a check-valve, etc. As part of the sprinkler valve 342 assembly, a quick attach/release coupler can be utilized to allow for quick removal and replacement of the sprinkler 340. In another embodiment, no sprinkler valve 342 is used. In yet another embodiment, the sprinkler 340 does not utilize a quick attach/release coupler and/or may not be easily replaced with other sprinkler heads.

The junction 345 can be a single multi-function device or it can comprise multiple components that act together to perform similar functions. In the embodiment shown in FIG. 3, the junction 345 accepts incoming liquid from the sprinkler pipe 344 or a mixture of liquid and chemicals from the mixer 319 (or a combination thereof) and routes the liquid and/or mixture to either the sprinkler 340 or the sprayer pipe 346. A check valve can be incorporated to ensure liquid does not flow backwards from the junction 345 into the sprinkler pipe 344 or into the mixer 319. The junction 345 also functions to accept mixed liquid and chemicals from the mixer 319 inside the storage/mixing chamber 318. The mixer 319 serves to agitate and mix chemicals placed inside the storage/mixing chamber 318 with incoming liquid supplied to the chamber 318 via the chamber input port 381.

Mixed liquid and chemicals can be directed by the junction 345 into the sprayer pipe 346. Turning the sprinkler valve 342 to “off” ensures that the mixture flows only into the sprayer pipe 346 and not out the sprinkler 340. The mixture flows through the sprayer pipe 346 and to the sprayer flow valve 334. The sprayer flow valve 334 can be actuated to control the flow of mixed or unmixed liquid to the sprayer 350. Mixed liquid enters the sprayer flow valve 334 from the sprayer pipe 346. Alternatively, unmixed, incoming liquid enters the sprayer flow valve 334 from the transfer pipe 333. The sprayer flow valve 334 can direct either of these flows up into the distribution pipe 335, it can provide for a mixture of these flows to enter the distribution pipe 335, or it can be closed and allow no flows.

Mixed or unmixed liquid can flow through the distribution pipe 335 and into the sprayer 350. Alternatively, a sprayer valve 358 can be placed between the distribution pipe 335 and the sprayer 350. The sprayer valve 358 can be a simple on/off valve or it can be a multi-function valve that allows flow control, quick-coupling removal and attachment of various sprayer wands, a check-valve, etc. In another embodiment, the sprayer 350 does not utilize a quick attach/release coupler and/or may not be easily replaced with other spray wands.

In the embodiment shown in FIG. 3, the sprayer 350 can utilize any of a plethora of known spray wands and can be made to be easily interchanged based upon the needs of the user. For example, a long-range spray wand can be used when the device 300 is employed to apply an incoming liquid or liquid/chemicals mixture to a distant target (such as the top of a tree). If, instead, the device 300 is employed to target individual weeds on the ground in proximity to the device 300, then a short-range spray wand can be used instead. The use of other types of misters, stream wands, atomizers, hand-held mixing sprayers, etc. is contemplated in place of the sprayer 350 depicted in FIG. 3.

Although FIG. 3 only illustrates a single storage/mixing chamber 318, it is contemplated that a plurality of chambers can be used. In one embodiment, the multi-directional valve 332 can select between any of the plurality of chambers, allowing the device 300 to mix the incoming liquid with different chemicals in each chamber either separately or together. In such an embodiment, multiple mixers 319 could be utilized (zero, one or more per chamber) and the junction 345 could receive an input from each chamber and route the mixture accordingly.

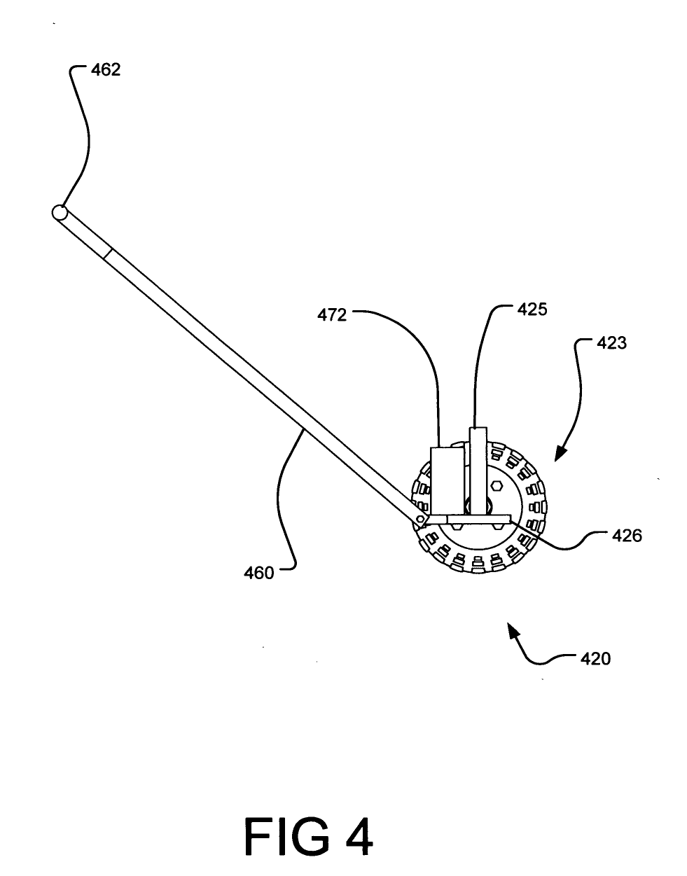

FIG. 4 illustrates a side elevation view depicting a portion of the front wheel assembly 420, the handle 462, tow bar 460, and electric pump 472 of a hand-pulled embodiment of a rolling lawn and garden sprinkler and sprayer. In the embodiment shown in FIG. 4, the pump 170 is not shown between the handle 462 and the tow bar 460. Nevertheless, in other embodiments both an electric pump 472 and a regular pump 170 can be used.

The electric pump 472 can be used to pressurize the storage/mixing chamber 318, assist in the mixing process, and/or to move liquid/chemicals through (and in and out of) the device 100. The electric pump 472 allows people who have difficulty operating a manual pump to use the device. The electric pump 472 can be powered via an on-board power source (such as a photovoltaic cell, battery pack, etc.) or it can plug into an external power source (110 volt AC household current, 12 volt DC current, etc.).

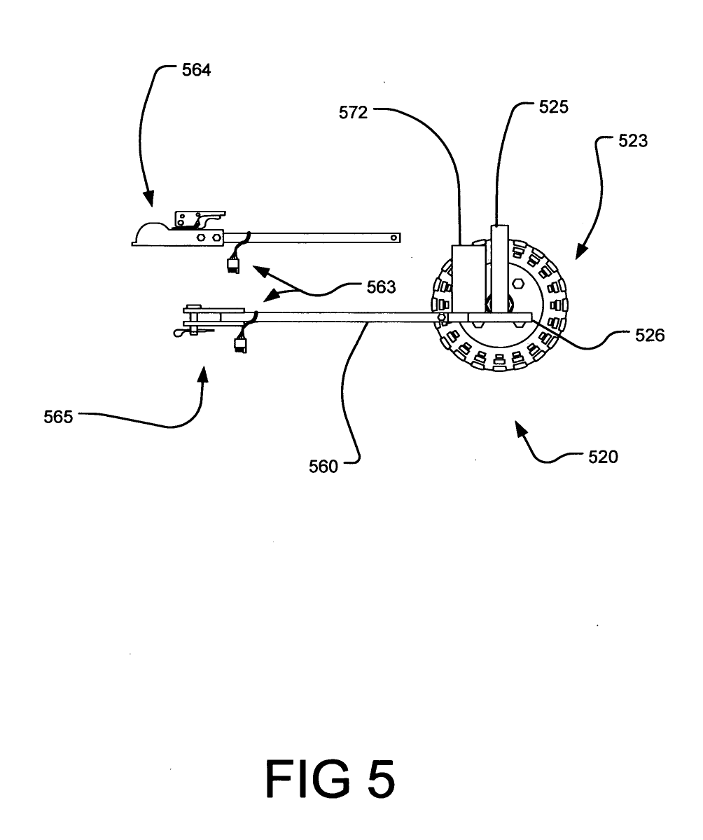

A front wheel support assembly 425 is also shown in FIG. 4. This structure allows for the front wheel plate assembly 426 to attach to the frame 310. The plate assembly 426 is attached to the wheels 423 and 421 (not shown here, see FIG. 2, wheel 221) and provides for a mounting location for the electric pump 472. Additionally, the tow bar 460 attaches to the plate assembly 426 as well. The distal end of the tow bar 460 attaches to the handle 462, allowing the device 100 to be maneuvered as needed by the user. In alternate embodiments, the tow bar 460 can attach to a hitch assembly which allows the device 100 to be towed and maneuvered by a vehicle (see FIG. 5).

FIG. 5 illustrates a side elevation view depicting a portion of the front wheel assembly 520, a plurality of hitch assemblies 564 and 565, and a pump 572 of a vehicle-pulled embodiment of a rolling lawn and garden sprinkler and sprayer. In the embodiment shown in FIG. 5, the pump 170 is not shown attached to the tow bar 560. Nevertheless, in other embodiments both an electric pump 572 and a regular pump 170 can be used.

A front wheel support assembly 525 is shown in FIG. 5. This structure allows for the front wheel plate assembly 526 to attach to the frame 310. The plate assembly 526 is attached to the wheels 523 and 521 (not shown here, see FIG. 2, wheel 221) and provides for a mounting location for the electric pump 572. Additionally, the tow bar 560 attaches to the plate assembly 526 as well. The distal end of the tow bar 560 attaches to the plurality of hitch assemblies 564 and 565, allowing the device 100 to be towed and maneuvered by a vehicle, such as an all terrain vehicle (ATV), lawn tractor or other tractor, light truck, etc. Also depicted in FIG. 5 is an electrical connector 563 that can be used to connect the electrical pump 572, lights, and/or any other electrical device to the power system of the tow vehicle or any other power source. Lights, although not shown, could be attached to the frame, sprayer, wheels, etc. and configured in any way currently known in the art.

The first hitch assembly 564 is configured with a ball hitch that attaches to a standard trailer ball attached to a tow vehicle. The first hitch assembly 564 can be sized to fit any of the ball sizes used in the industry. The second hitch assembly 565 is configured with a pin hitch that attaches to any trailer hitch requiring a hitch pin.

The above specification, examples and data provide a description of the structure and use of exemplary embodiments of the described articles of manufacture and methods. It will further be understood from the foregoing description that various modifications and changes may be made in the embodiments of the present invention without departing from its true spirit. This description is intended for purposes of illustration only and should not be construed in a limiting sense. The scope of this invention should be limited only by the language of the following claims.

What is claimed is:

1. A rolling lawn and garden sprinkler and sprayer, comprising:
a frame having an inside and an outside;
an access port placed on the frame that allows access to the inside of the frame;
a wheeled chassis attached to the outside of the frame and supporting the frame, and having a plurality of wheels;
an input port configured to accept attachment to a source of incoming liquids;
a plurality of mixing/storage chambers located inside the frame and configured to accept and contain a plurality of chemicals, fertilizers, pesticides, herbicides, and insecticides;
a sprinkler assembly designed to disperse a liquid over an area;
a sprayer assembly designed for spot application of the liquid;
a multi-directional valve that allows a user to selectively direct an incoming liquid to a plurality of routes and wherein a first route is from the input port to the sprinkler assembly and a second route is from the input port to the sprayer assembly;
and a tow bar configured to allow the user to maneuver the sprinkler and sprayer.

2. The sprinkler and sprayer of claim 1 wherein the plurality of wheels have inflatable turf-type tires attached thereto to minimize damage to surfaces and vegetation across which the sprinkler and sprayer is maneuvered.

3. The sprinkler and sprayer of claim 1 wherein the input port is configured with a female garden hose connection for attachment of a garden hose thereto.

4. The sprinkler and sprayer of claim 1 wherein a third route is from the input port to the plurality of mixing/storage chambers.

5. The sprinkler and sprayer of claim 1 wherein the sprinkler assembly can utilize interchangeable sprinkling heads and wherein the sprayer can utilize interchangeable spray wands.

6. The sprinkler and sprayer of claim 1 further comprising a pump configured to pressurize at least one of the plurality of mixing/storage chambers.

7. The sprinkler and sprayer of claim 1, wherein the frame is shaped so as to resemble a large ladybug.

8. The sprinkler and sprayer of claim 7, wherein a plurality of spots and a representation of a head of a ladybug are placed on the outside of the frame to enhance the resemblance of the frame to a ladybug.

9. A rolling lawn and garden sprinkler and sprayer, comprising:
a frame having an inside and an outside;
an access port placed on the frame that allows access to the inside of the frame.
a wheeled chassis attached to the outside of the frame and supporting the frame, and having a plurality of wheels;
an input port configured to accept attachment to a source of incoming liquids;
a plurality of mixing/storage chambers located inside the frame and configured to accept and contain a plurality of chemicals, fertilizers, pesticides, herbicides, and insecticides;
a sprinkler assembly designed to disperse a liquid over an area;
a sprayer assembly designed for spot application of the liquid;
a multi-directional valve that allows a user to selectively direct an incoming liquid to a plurality of routes and wherein a first route is from the input port to the sprinkler assembly, a second route is from the input port to the sprayer assembly, and a third route is from the input port to the plurality of mixing/storage chambers;
and a tow bar configured to allow the user to maneuver the sprinkler and sprayer.

10. The sprinkler and sprayer of claim 9, further comprising:
a plurality of mixers located in each of the plurality of mixing/storage containers and configured to mix the incoming liquid with the plurality of chemicals, fertilizers, pesticides, herbicides, and insecticides and to distribute a resulting mixture to a junction, wherein the junction is connected to the sprayer assembly and to the sprinkler assembly and is configured to selectively distribute the mixture through a plurality of flow paths where a first flow path is from the junction to the sprinkler assembly and a second flow path is from the junction to the sprayer assembly

11. The sprinkler and sprayer of claim 10 wherein the plurality of wheels have inflatable turf-type tires attached thereto to minimize damage to surfaces and vegetation across which the sprinkler and sprayer is maneuvered.

12. The sprinkler and sprayer of claim 10 wherein the input port is configured with a female garden hose connection for attachment of a garden hose thereto.

13. The sprinkler and sprayer of claim 10 wherein the input port is in proximity to an input valve that allows an input flow to be selectively restricted by the user.

14. The sprinkler and sprayer of claim 10, wherein the frame is shaped so as to resemble a large ladybug.

15. The sprinkler and sprayer of claim 14, wherein a plurality of spots and a representation of a head of a ladybug are placed on the outside of the frame to enhance the resemblance of the frame to a ladybug.

16. The sprinkler and sprayer of claim 10 further comprising a pump configured to pressurize at least one of the plurality of mixing/storage chambers.

17. The sprinkler and sprayer of claim 15 further comprising a pump configured to pressurize at least one of the plurality of mixing/storage chambers.

18. The sprinkler and sprayer of claim 17 wherein a flow through the sprinkler assembly can be restricted via a sprinkler valve and wherein a flow through the sprayer assembly can be restricted via a sprayer valve.

19. The sprinkler and sprayer of claim 18 wherein the tow bar can be selectively configured to be pulled by a plurality of tow devices and where a first tow device is a handle configured to be held by a hand of the user, a second tow device is a ball hitch configured to attach to a ball on a tow vehicle, and a third tow device is a pin hitch configured to attach via a hitch pin to the tow vehicle.

20. A rolling lawn and garden sprinkler and sprayer, comprising:
a frame having an inside and an outside;
an access port placed on the frame that allows access to the inside of the frame.
a wheeled chassis attached to the outside of the frame and supporting the frame, and having a plurality of wheels wherein the wheels have inflatable turf-type tires attached thereto;
an input port configured to accept attachment via a female garden hose connection to a garden hose that can direct an incoming liquid into the input port;
an input valve in proximity to the input port, the input valve configured to accept the incoming liquid from the input port and to allow a user to selectively restrict an outflow of the incoming liquid from the input valve;
a plurality of mixing/storage chambers located inside the frame and configured to accept and contain a plurality of chemicals, fertilizers, pesticides, herbicides, and insecticides and wherein the frame is shaped so as to resemble a large ladybug, and where a plurality of spots and a representation of a head of a ladybug are placed on the outside of the frame to enhance the resemblance of the frame to a ladybug;
a sprinkler assembly designed to disperse a liquid over an area;
a sprayer assembly designed for spot application of the liquid;
a multi-directional valve that receives the outflow of the incoming liquid from the input valve, the multi-directional valve configured to allow the user to selectively direct the incoming liquid to a plurality of routes and wherein a first route is from the input valve to the sprinkler assembly, a second route is from the input valve to the sprayer assembly, and a third route is from the input valve to the plurality of mixing/storage chambers;
a tow bar configured to allow the user to maneuver the sprinkler and sprayer;
a plurality of mixers located in each of the plurality of mixing/storage containers and configured to mix the incoming liquid with the plurality of chemicals, fertilizers, pesticides, herbicides, and insecticides and to distribute a resulting mixture to a junction, wherein the junction is connected to the sprayer assembly and to the sprinkler assembly and is configured to allow the user to selectively distribute the mixture through a plurality of flow paths where a first flow path is from the junction to the sprinkler assembly and a second flow path is from the junction to the sprayer assembly;
a pump configured to pressurize at least one of the plurality of mixing/storage chambers;
and a sprinkler valve configured to allow the user to selectively restrict a flow through the sprinkler assembly and a sprayer valve configured to allow the user to selectively restrict a flow through the sprayer assembly.
